(19) United States
(12) Patent Application Publication
(10) Pub. No.: US 2015/0343809 A1
(43) Pub. Date: Dec. 3, 2015

(54) PRINTER

(71) Applicant: FUNAI ELECTRIC CO., LTD., Osaka (JP)

(72) Inventor: Ryuji AOKI, Ikoma-shi (JP)

(21) Appl. No.: 14/724,088

(22) Filed: May 28, 2015

(30) Foreign Application Priority Data
May 29, 2014 (JP) 2014-111701

(51) Int. Cl. B41J 13/00

(52) U.S. Cl. CPC B41J 13/0009

(57) ABSTRACT

A printer includes: a pattern printing unit that forms a first mark on a first side of a document and forms a second mark on a second side of the document; a glass platen for placing the document including the first mark and the second mark formed by the pattern printing unit; a main body including a third mark depicted in at least one portion of an area surrounding the glass platen; a scanner function unit that reads the first mark formed on the first side of the document placed on the glass platen; and an adjusting unit that adjusts a printing position based on a result obtained by reading the first mark. The second mark is positioned opposite to the third mark when the first mark is read by the scanner function unit.

### CROSS REFERENCE TO RELATED APPLICATION

The present application is based on and claims priority of Japanese Patent Application No. 2014-111701 filed on May 29, 2014. The entire disclosure of the above-identified applications, including the specifications, drawings and claims is incorporated herein by reference in its entirety.

### FIELD

The present invention relates to printers, particularly a printer that includes a plurality of ink cartridges and a scanner.

### BACKGROUND

Known printers include multifunction printers which have, for example, a color printing function for printing in color, a duplex printing unit for printing on both sides of a medium, and a scanner for optically reading a document.

Note that inkjet printers having a color printing function generally include, as the ink cartridges, a monochrome cartridge containing black ink and a color cartridge containing, for example, cyan (C) ink, magenta (M) ink, and yellow (Y) ink.

With printers that include a plurality of ink cartridges, after an ink cartridge has been replaced, misalignment between the printing position of the print head of the monochrome cartridge and the printing position of the print heads corresponding to the colors contained in the color cartridge may arise from, for example, dimensional variations in ink cartridges. Misalignment between the printing positions of the plurality of print heads reduces print quality.

A printer is known which addresses this issue of misalignment between printing positions. This printer, for example, uses the monochrome cartridge print head and the color cartridge print heads to print a position detection pattern for detecting the printing positions of the print heads and then reads the position detection pattern using the scanner to detect an amount of misalignment. This printer adjusts the printing position of the monochrome cartridge or the printing positions of the color cartridge using the detected amount of misalignment to align the printing area of the black ink and the printing area of the color ink.

### CITATION LIST

### Patent Literature

[PTL 1] Japanese Unexamined Patent Application Publication No. 2004-106239

### SUMMARY

### Technical Problem

However, with this printer, the printing and scanning of the position detection pattern is done by hand by the user, and user error sometimes occurs.

Accordingly, an object of the present invention is to provide a printer which can reduce user error in adjusting the position of a print head.

### Solution to Problem

In order to achieve the above-described object, a printer according to one aspect of the present invention includes: an image forming unit that forms a first mark on a first side of a medium and forms a second mark on a second side of the medium; a platen for placing the medium including the first mark and the second mark formed by the image forming unit; a frame including a third mark depicted in at least one portion of an area surrounding the platen; a reading unit that reads the first mark formed on the first side of the medium placed on the platen; and an adjusting unit that adjusts a printing position based on a result obtained by reading the first mark. The second mark is positioned opposite to the third mark when the reading unit reads the first mark.

With the above-described printer, since the second mark for assisting the user is formed on the second side of the medium, user error when setting the medium on the platen can be reduced. Moreover, with the above-described printer, since the second mark is formed on the second side of the medium in a position that corresponds with the third mark depicted in at least one portion of an area surrounding the platen, the user can easily recognize the position in which to set the medium.

For example, the printer may further include a carriage that includes one or more print heads and reciprocates along a predetermined axis, and the adjusting unit may adjust a printing position of the one or more print heads based on the result obtained by reading the first mark.

With the above-described printer, when the carriage includes one or more print heads, the printing position of each of the one or more print heads can be adjusted.

For example, the one or more print heads may include a first print head and a second print head, the first mark may include a first pattern and a second pattern, the image forming unit may print the first pattern using the first print head and print the second pattern using the second print head, and the adjusting unit may detect a distance between the first pattern and the second pattern from the result obtained by reading the first mark and adjust a print timing of the second print head based on the distance between the first pattern and the second pattern.

With the above-described printer, when the one or more print heads includes a first print head and a second print head, misalignment between the printing positions of the first print head and the second print head can be reduced.

For example, a monochrome cartridge containing black ink and a color cartridge containing color ink may be attached to the carriage, the first print head may correspond to one of the monochrome cartridge and the color cartridge, and the second print head may correspond to an other of the monochrome cartridge and the color cartridge.

With the above-described printer, a print timing of a print head corresponding to one of the monochrome cartridge and the color cartridge can be adjusted.

For example, the first pattern and the second pattern may be alternately arranged in a translating direction of the carriage.

With the above-described printer, the first pattern and the second pattern can be alternately arranged in the translating direction of the carriage.

For example, the first mark may include a third pattern and a fourth pattern, the image forming unit may print the third pattern when the carriage is translating in a first direction and print the fourth pattern when the carriage is translating in a second direction opposite the first direction, and the adjusting unit may detect a distance between the third pattern and the fourth pattern from the result obtained by reading the first mark and, based on the distance between the third pattern and the fourth pattern, adjust a print timing of the one or more print heads when the one or more print heads are translating in the second direction

With the above-described printer, print misalignment arising from reciprocation of one print head can be reduced.

For example, a monochrome cartridge containing black ink and a color cartridge containing color ink may be attached to the carriage, and the third pattern and the fourth pattern may both be printed using the print head corresponding to one of the monochrome cartridge and the color cartridge.

With the above-described printer, the third pattern and the fourth pattern can be printed using a print head corresponding to one of the monochrome cartridge and the color cartridge.

For example, the image forming unit may form the second mark on the second side, in a region corresponding to a region on the first side in which the first mark is not formed.

With the above-described printer, when the medium (for example, printed paper) is thin and produces show-through upon scanning, since the first mark for printing position detection does not overlap with the second mark for assisting the user, even if the second mark were to show through, the first mark can be sufficiently read. Thus, with the above-described printer, printing timing adjustment accuracy can be kept from decreasing.

For example, the printer may further include a duplex printing unit capable of automatically printing on both the first side and the second side of the medium, and the image forming unit may form the first mark on the first side of the medium and form the second mark on the second side of the medium using the duplex printing unit.

With the above-described printer, using the duplex printing function of the duplex printing unit, the first mark can be formed on the first side of the medium and the second mark can be formed on the second side of the medium.

For example, the second mark may resemble the third mark.

With the above-described printer, the user can easily recognize the position in which to set the medium.

Note that the present invention can be implemented not only as a printer including these characterizing processing units, but also as a printing method which employs the processes performed by the characterizing processing units included in the printer as steps. The present invention can also be implemented as a computer program that causes a computer to function as the characterizing processing units included in the printer, or a computer program that causes a computer to execute the characterizing steps included in the printing method. It goes without saying that this computer program can be circulated on a non-transitory computer-readable storage medium such as a compact disc-read only memory (CD-ROM), or over a communications network such as the Internet.

### Advantageous Effects

The present invention reduces user error in adjusting the position of a print head.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 illustrates a top surface of a chassis of a printer according to an embodiment.

FIG. 2 is a block diagram illustrating an example of a configuration of a printer according to an embodiment.

FIG. 3 illustrates an example of a carriage according to an embodiment.

FIG. 4 is a flow chart illustrating steps for correcting misalignment according to an embodiment.

FIG. 5A illustrates an example of a position detection pattern according to an embodiment.

FIG. 5B illustrates an example of a position detection pattern according to a first variation.

FIG. 5C illustrates an example of a position detection pattern according to a second variation.

FIG. 6 illustrates an example of a design for assisting a user according to an embodiment.

FIG. 7 illustrates the document illustrated in FIG. 5A and FIG. 6 when it is set on a glass platen.

FIG. 8 illustrates an example of a design for assisting the user according to a third variation.

FIG. 9 illustrates an example of a printer when the document illustrated in FIG. 5C is being set on a glass platen, according to an embodiment.

### DESCRIPTION OF EMBODIMENT

Hereinafter, an illustrative embodiment is described in greater detail with reference to the accompanying drawings. Note that the Drawings are schematic drawings, and may not depict exact dimensions or dimensional ratios.

The illustrative embodiment described below shows a general or specific example. The numerical values, shapes, structural elements, the arrangement and connection of the structural elements, steps, the processing order of the steps etc. shown in the following illustrative embodiment are mere examples, and therefore do not limit the scope of the present invention, which is limited by the appended Claims. Therefore, among the structural elements in the following illustrative embodiment, structural elements not recited in any one of the independent claims are described as preferred structural elements, and are not absolutely necessary to overcome the problem according to the present invention.

### Embodiment

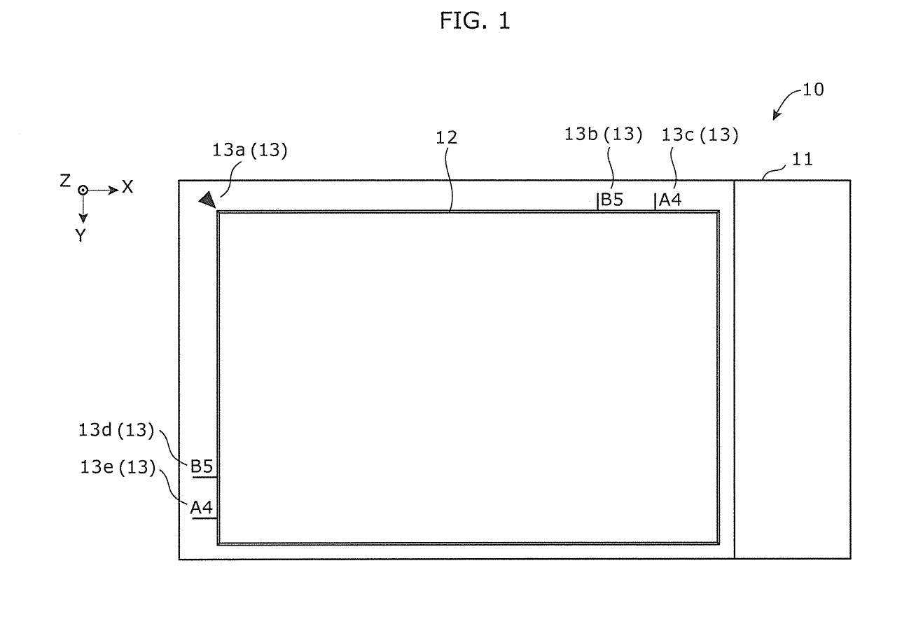

The printer according to this embodiment will be described with reference to FIG. 1 through FIG. 7.

The printer according to this embodiment is a multifunction printer having, for example, a color printing function for printing in color, a duplex printing unit for printing on both sides of a medium, and a scanner for optically reading a document.

### 1-1 Configuration

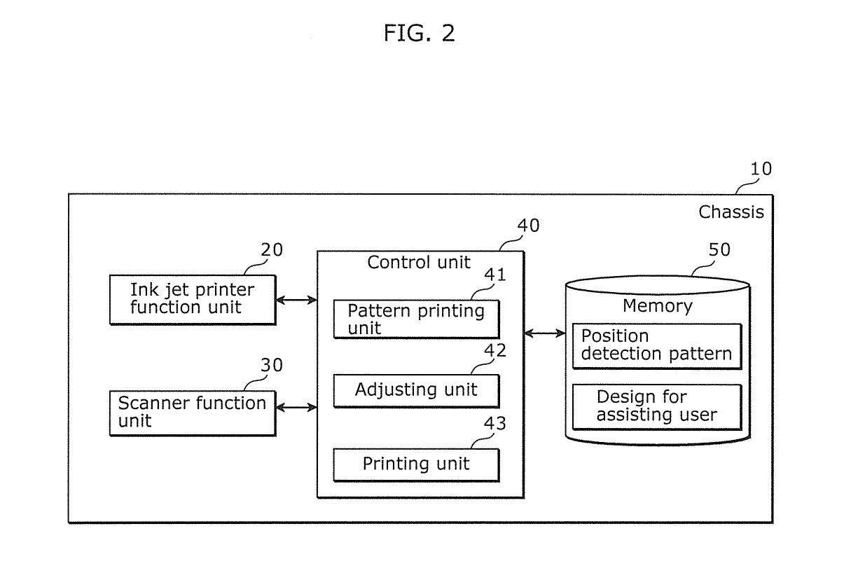

FIG. 1 illustrates a top surface of a chassis, which includes a platen, of the printer according to this embodiment. FIG. 2 is a block diagram of an example of a configuration of the printer according to this embodiment.

The printer according to this embodiment includes, in the chassis 10, an ink jet printer function unit 20 (one example of the duplex printing unit), a scanner function unit 30 (one example of the reading unit), a control unit 40, and a memory 50.

The chassis 10 includes a main body 11 (one example of the frame) having a glass platen 12 in the top surface, and a lid (not shown in the Drawings) which covers the glass platen 12. The glass platen 12 is an example of a platen for placing a document (one example of the medium), and is disposed so as to cover a rectangular opening formed in the top surface of the main body 11.

A third mark 13 is depicted on the top surface of the main body 11, near the top and left sides of the opening (glass platen 12) (in other words, depicted in at least one portion of an area surrounding the glass platen 12). The third mark 13 indicates a position for placing the document. In this embodiment, the third mark 13 includes an isosceles triangle 13a indicating the origin for positioning the document, text 13b and text 13d indicating positions corresponding to the edges of a B5 size document, and text 13c and text 13e indicating positions corresponding to the edges of an A4 size document. The isosceles triangle 13a is depicted near the top left corner of the opening. The text 13b and text 13c are depicted near the top side of the opening. The text 13d and text 13e are depicted near the left side of the opening.

The ink jet printer function unit 20 is a functional unit that performs the printing, and includes a drive mechanism for the carriage that holds the ink cartridges and a drive mechanism for the conveyor roller that conveys the medium. The ink jet printer function unit 20 according to this embodiment is also capable of automated duplex printing.

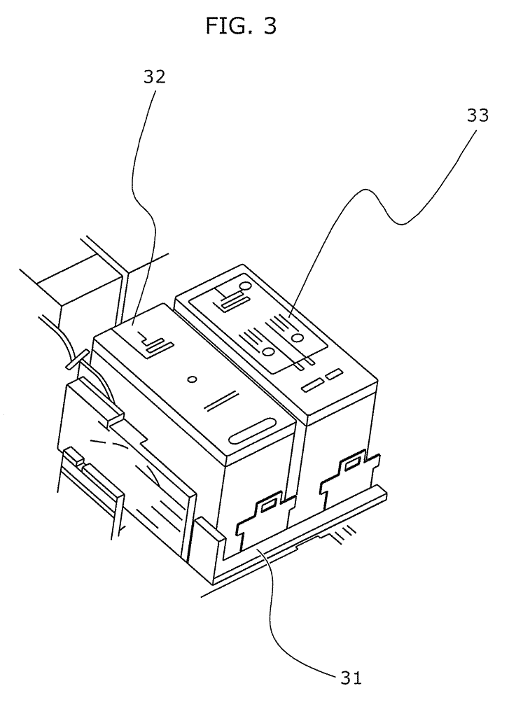

FIG. 3 illustrates an example of a carriage 31 according to this embodiment. As illustrated in FIG. 3, the carriage 31 can be loaded with a monochrome cartridge 32 that contains black ink and a color cartridge 33 that contains, for example, cyan (c) ink, magenta (M) ink, and yellow (Y) color ink. In this embodiment, the monochrome cartridge 32 and the color cartridge 33 are exemplified as including a print head, but the monochrome cartridge 32 and the color cartridge 33 are not limited to this example. The cartridges and the print heads may be provided as separate components. The print heads may also be provided on the carriage 31 instead of the cartridges.

The carriage 31 reciprocates along a predetermined axis, along a rail disposed parallel to the X axis in the chassis 10. In other words, the carriage 31 translates back and forth horizontally when printing (i.e., in directions along the X axis illustrated in FIG. 1). Printing is performed both when the carriage 31 is translating in the positive direction of the X axis and translating in the negative direction of the X axis.

The scanner function unit 30 is a scanner that optically reads a document placed on the glass platen 12. The scanner function unit 30 is disposed below the glass platen 12 and includes a light source (not shown in the Drawings) that projects light onto the document, and a light receiving unit (not shown in the Drawings) that receives light reflected off the document.

The light receiving unit includes a plurality of light receiving elements aligned along the Y axis, and reciprocates along a rail disposed parallel to the X axis in the chassis 10. When, for example, scanning an A4 size document, the scanner function unit 30 activates the light receiving elements disposed between the upper end and a position equivalent to the end of the A4 document along the Y axis (the position of the text 13e) (in other words, the light receiving elements disposed directly below the document set on the glass platen 12. Furthermore, the scanner function unit 30 translates along the X axis between the leftmost end and the end of the A4 document along the X axis (the position of the text 13c) while the light receiving elements that perform the scanning are activated.

The control unit 40 controls printing, including the adjustment of the printing position of the print head of the monochrome cartridge (the first print head) or the printing position of the print heads of the color cartridge (second print heads). As illustrated in FIG. 2, the control unit 40 includes a pattern printing unit 41 (one example of the image forming unit), an adjusting unit 42, and a printing unit 43.

With duplex printing, the pattern printing unit 41 prints a position detection pattern (first mark) on a first side of the document and prints a design (second mark) on the second side of the document. The position detection pattern (first mark) is for detecting the printing position of one or more cartridges. The design (second mark) is for assisting the user and resembles the third mark 13. The design (second mark) is printed so as to be adjacent the third mark 13 depicted on the chassis 10 when the document is set in position on the glass platen 12.

Here, the second mark resembling the third mark 13 may include, for example, a design in which the third mark is rotated, a design in which the size of the third mark is changed, or a design in which a portion (for example, a characterizing portion) of the third mark is omitted. Moreover, the second mark may be text representing the meaning of the third mark, such as the word “circle” for a depiction of a circle, and if the third mark is text, the second mark may be a graphic representing the meaning of the text, for example.

In correcting misalignment, the adjusting unit 42 uses the scanner function unit 30 (scanner) to scan the position detection pattern printed on the first side of the document placed on the glass platen 12, and adjusts the printing position of the one or more cartridges using the result of the scan. More specifically, the adjusting unit 42 calculates an offset value for adjusting the timing of the printing.

When a printing job is requested, the printing unit 43 adjusts the timing of the printing using the offset value calculated by the adjusting unit 42.

### 1-2 Operation

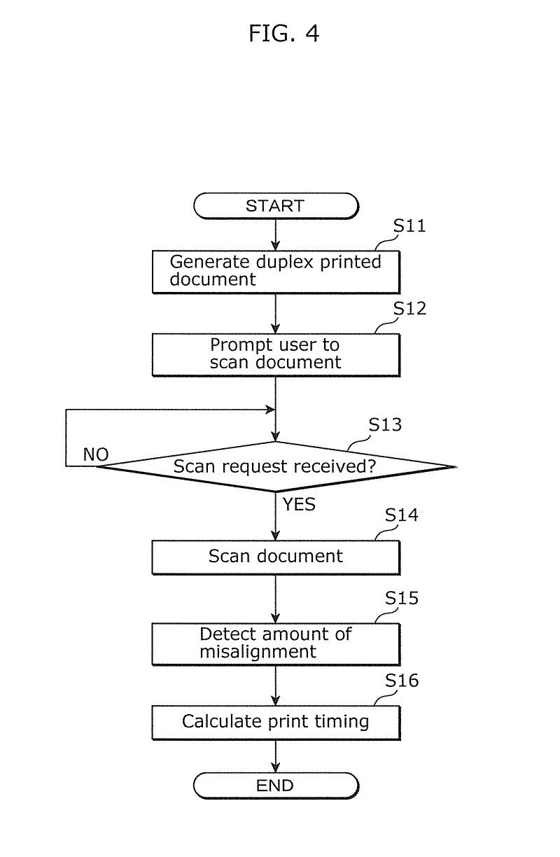

Next, misalignment correction will be described with reference to FIG. 4

FIG. 4 is a flow chart illustrating steps for correcting misalignment according to this embodiment.

The process for correcting misalignment is performed, for example, after replacing a cartridge, or after receiving an input requesting misalignment correction by the user. Note that the timing at which the process for correcting misalignment is performed may be arbitrary. For example, the process for correcting misalignment may be performed at regular time intervals, or performed each time after a given number of pages have been printed.

When the process for correcting misalignment is started, the pattern printing unit 41 uses the duplex printing unit to print, on the first side of the document, a position detection pattern for detecting the printing position of one or more cartridges and print, on the second side of the document, a design that is for assisting the user and resembles the third mark 13 depicted on the chassis 10 (S11).

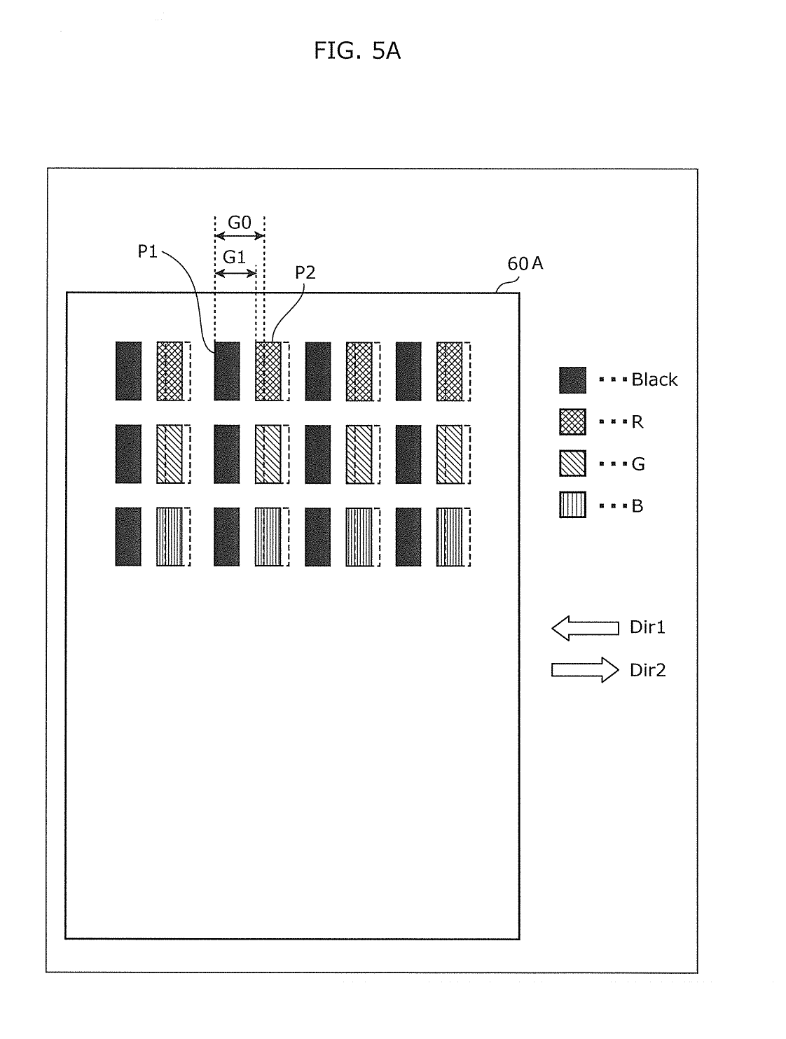

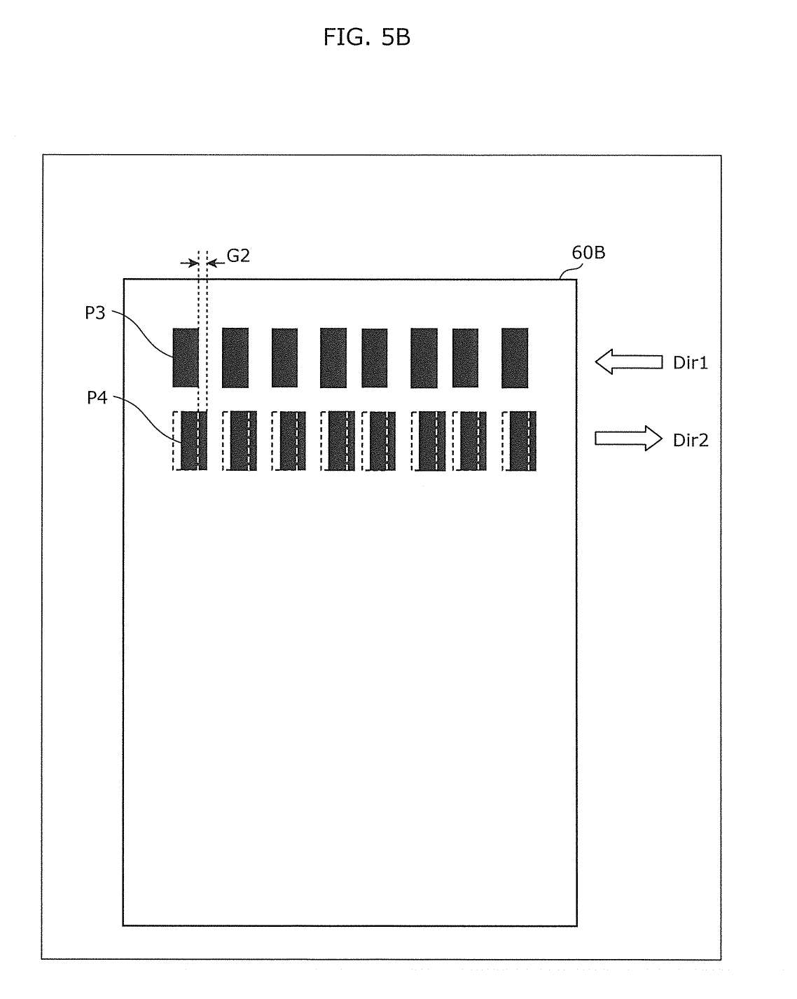

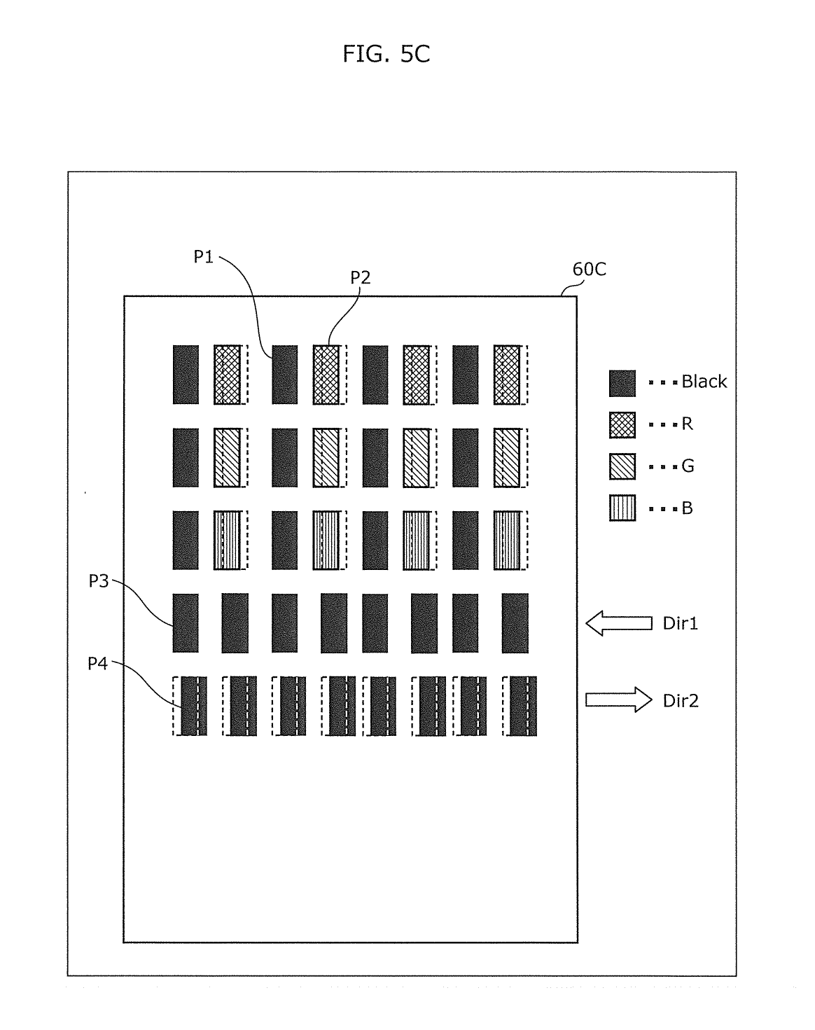

FIG. 5A illustrates an example of a position detection pattern according to this embodiment. As illustrated in FIG. 5A, the position detection pattern includes a plurality of patterns P1 (first patterns) and a plurality of patterns P2 (second patterns). The patterns P1 are rectangular patterns printed using the monochrome cartridge 32. The patterns P2 are rectangular patterns printed using the color cartridge 33. In this embodiment, the patterns P1 and the patterns P2 are the same size and shape. Moreover, the patterns P1 and the patterns P2 are printed in a matrix of three rows and eight columns. In FIG. 5A, since the color cartridge contains three colors, the patterns P2 include three patterns: a red (R) pattern, a green (G) pattern, and a blue (B) pattern. Each pattern P1 is a black pattern. In the first row, black patterns P1 and red (R) patterns P2 are alternately disposed. In the second row, black patterns P1 and green (G) patterns P2 are alternately disposed. In the third row, black patterns P1 and blue (B) patterns P2 are alternately disposed.

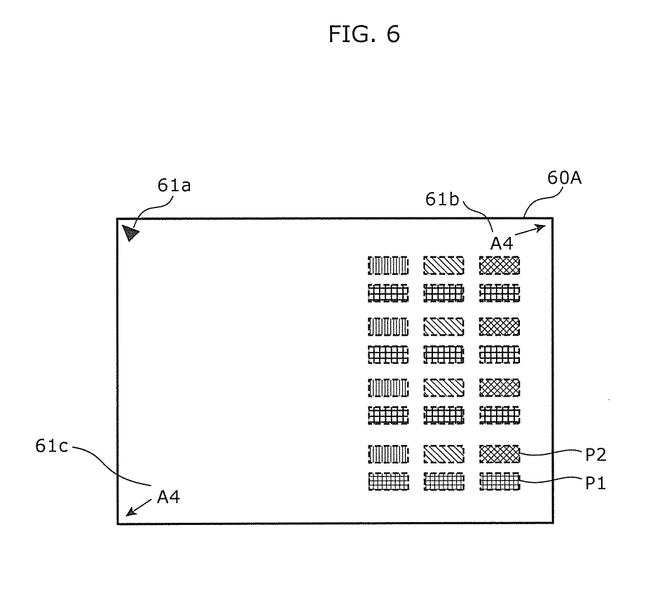

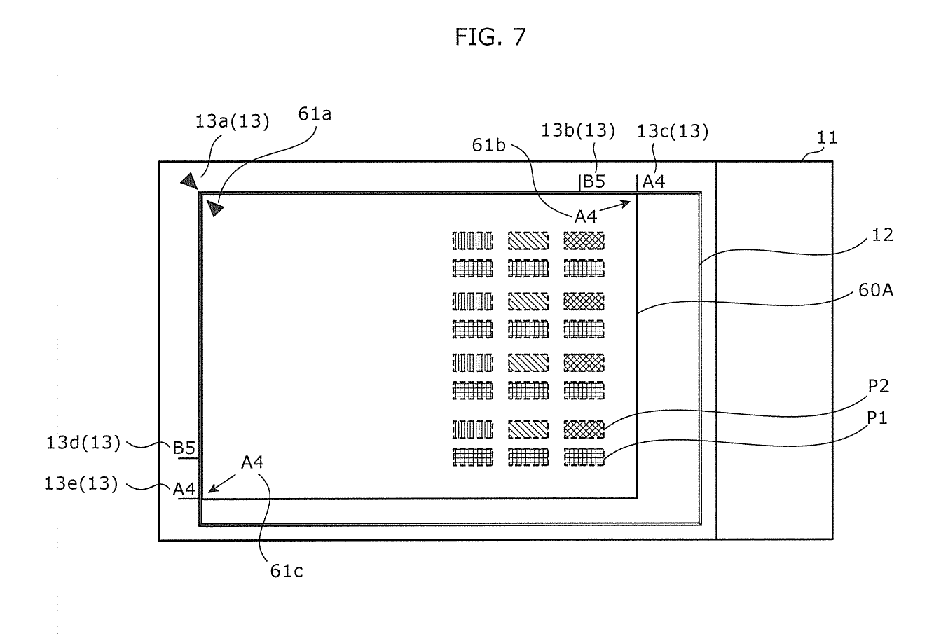

FIG. 6 illustrates an example of a design for assisting the user according to this embodiment. FIG. 7 illustrates the document 60A illustrated in FIG. 5A and FIG. 6 when it is set on the glass platen. Note that for the purpose of showing the positional relationship between the position detection pattern printed on the front side of the document and the design for assisting the user printed on the back side of the document, the position detection pattern is also illustrated in FIG. 6 and FIG. 7. If the document 60A is a document that does not pass light, the position detection pattern will not show through on the back side.

As illustrated in FIG. 6, an isosceles triangle 61a, text 61b, and text 61c are printed on the second side of the document 60A (i.e., the back side of the document 60A) as the design for assisting the user. The isosceles triangle 61a, text 61b, and text 61c resemble the isosceles triangle 13a, text 13c, and text 13e depicted on the chassis 10 as illustrated in FIG. 1. As illustrated in FIG. 7, when the document 60A is placed on the glass platen 12, the printed isosceles triangle 61a is disposed a position rotated 180 degrees about the origin point relative to the isosceles triangle 13a. As illustrated in FIG. 7, the printed text “A4” as the text 61b and text 61c is printed near where “A4” is depicted as the text 13c and text 13e on the chassis 10. In this embodiment, an arrow is also printed to more clearly point out where the printed “A4” is indicating. Note that a pattern corresponding to “B5”, which is an example of the text 13b and text 13d, may also be printed, and a pattern corresponding to “B5” in place of “A4” as the text 61b and text 61c may be printed.

Note that in this embodiment, as illustrated in FIG. 6 and FIG. 7, the design for assisting the user is arranged so as to not overlap the position detection pattern. This makes it possible to accurately read the position detection pattern even if, for example, show through were to occur when scanning.

The adjusting unit 42 uses the pattern printing unit 41 to print the position detection pattern on the first side of the document 60A and print the design for assisting the user on the second side of the document 60A, and after the document 60A is ejected from the printer, the user is prompted to scan the document 60A (S12). More specifically, if, for example, the chassis 10 includes a display unit, “please set the document in place on the scanner and scan the document”, for example, is displayed to prompt the user. Alternatively, if the printer includes an audio output function, audio of the above sentence may be output.

When the document 60A is set on the glass platen 12 and a scan request is received (Yes in S13), the adjusting unit 42 scans the document 60A using the scanner function unit 30 (S14).

The adjusting unit 42 detects the amount of misalignment on the document 60A (S15). More specifically, the adjusting unit 42 detects the distance between a pattern P1 and a pattern P2 printed on the document 60A illustrated in FIG. 5A. The adjusting unit 42 calculates the amount of misalignment by calculating the difference G0-G1 between the set distance G0 between pattern P1 and pattern P2 set for printing and the detected distance G1 between pattern P1 and pattern P2.

In the above description, a method of calculating the amount of misalignment between the black pattern P1 and the red (R) pattern P2 in the first row is described, but the same method is used to calculate the amount of misalignment between the black pattern P1 and the green (G) pattern P2 in the second row, and calculate the amount of misalignment between the black pattern P1 and the blue (B) pattern P2 in the third row.

When the amount of misalignment is not zero, the adjusting unit 42 calculates a print timing adjustment amount for correcting the misalignment (S16). For example, in the case of document 60A illustrated in FIG. 5A, since the amount of misalignment between the black pattern P1 and the red (R) pattern P2 is not zero, the adjusting unit 42 calculates a print timing that results in a shift of the printing position by the misalignment amount G0-G1, i.e., calculates a correction amount ΔT1 for the timing at which the ink is dispensed from the red (R) print head of the color cartridge, and ends the process for correcting misalignment. Similarly, since the amount of misalignment between the black pattern P1 and the green (G) pattern P2 is not zero, the adjusting unit 42 calculates a correction amount for the timing at which the ink is dispensed from the green (G) print head. Similarly, since the amount of misalignment between the black pattern P1 and the blue (B) pattern P2 is not zero, the adjusting unit 42 calculates a correction amount for the timing at which the ink is dispensed from the blue (B) print head.

Note that the printing unit 43 adjusts the print timing of the color cartridge 33 based on the direction in which the carriage 31 is translating. For example, for the misalignment illustrated in FIG. 5A, when the carriage is translating in direction Dir1, the printing unit 43 advances the print timing for the red (R) print head of the color cartridge 33 by the correction amount ΔT1 calculated by the adjusting unit 42. When the carriage is translating in direction Dir2, the printing unit 43 retards the print timing for the red (R) print head of the color cartridge 33 by the correction amount ΔT1 calculated by the adjusting unit 42. This reduces print misalignment between the monochrome cartridge 32 and the color cartridge 33, thus increasing print quality. Print timing for the green (G) print head and blue (B) print head is adjusted in the same manner.

Note that in this embodiment, the print timing for the red (R), green (G), and blue (B) print heads of the color cartridge 33 is adjusted, but the print timing for the print head of the monochrome cartridge 32 may be adjusted.

### 1-3 Advantageous Effect

In this embodiment, since the design for assisting the user is printed on the back side of the document using the duplex printing unit, user error, such as setting the document in the incorrect orientation, can be reduced. This reduces the number of erroneous scans that are made, thereby reducing the overall amount of power consumed as a result of performing the process for correcting misalignment.

Moreover, in this embodiment, since the design for assisting the user is a pattern resembling the third mark depicted on the chassis 10, the user can intuitively recognize the correct orientation in which to set the document.

### First Variation

The printer according to the first variation will be described with reference to FIG. 5B.

In the above embodiment, print timing is adjusted to correct print misalignment occurring between two cartridges, but in the first variation, print misalignment arising from translation of the carriage is corrected.

Similar to the above-described embodiment, the printer according to the first variation includes, in the chassis 10, the ink jet printer function unit 20, the scanner function unit 30, the control unit 40, and the memory 50, as illustrated in FIG. 1 and FIG. 2. Note that the printer according to the first variation differs from the printer according to the above-described embodiment in operation, but the configuration of the chassis 10, the ink jet printer function unit 20, the scanner function unit 30, the control unit 40, and the memory 50 is the same.

Operations performed by the printer according to the first variation will be described with reference to FIG. 4. Note that the timing at which the process for correcting misalignment is performed is the same as described above in the embodiment.

When the process for correcting misalignment is started, the pattern printing unit 41 uses the duplex printing unit to print the position detection pattern on the first side of the document and print the design for assisting the user on the second side of the document (S11).

In the first variation, the pattern illustrated in FIG. 5B is printed as the position detection pattern.

FIG. 5B illustrates an example of the position detection pattern according to the first variation. As illustrated in FIG. 5B, the position detection pattern according to the first variation includes a plurality of patterns P3 (third patterns) and a plurality of patterns P4 (fourth patterns). The patterns P3 and the patterns P4 are printed by the print head of the monochrome cartridge 32, and are the same size and shape. Moreover, the patterns P3 and the patterns P4 are printed in a matrix of two rows and eight columns. Each pattern P3 and pattern P4 is a black pattern. The first row of patterns P3 is printed when the carriage 31 translates in the direction Dir1, and the second row of patterns P4 is printed when the carriage 31 translates in the direction Dir2.

The design for assisting the user is the same as the design for assisting the user according to the above-described embodiment and illustrated FIG. 6.

The adjusting unit 42 uses the pattern printing unit 41 to print the position detection pattern on a first side of a document 60B and print the design for assisting the user on the second side of the document 60B, and after the document 60B is ejected from the printer, the user is prompted to scan the document 60B (S12).

When the document 60B is set on the glass platen 12 and a scan request is received (Yes in S13), the adjusting unit 42 scans the document 60B using the scanner function unit 30 (S14).

The adjusting unit 42 detects an amount of misalignment on the document 60B (S15). In the first variation, the adjusting unit 42 detects a distance G2 between a pattern P3 and a pattern P4 printed on the document 60B illustrated in FIG. 5B. The adjusting unit 42 calculates the distance G2 as the amount of misalignment. If there is no misalignment, the distance G2 is zero.

When the amount of misalignment is not zero, the adjusting unit 42 calculates a print timing adjustment amount for correcting the misalignment (S16). For example, in the case of document 60B illustrated in FIG. 5B, since the amount of misalignment is not zero, the adjusting unit 42 calculates a correction amount ΔT2 for the timing at which the ink is dispensed from the print head of the monochrome cartridge 32, and ends the process for correcting misalignment.

Note that under normal printing circumstances, when the carriage 31 is translating in direction Dir2, the printing unit 43 advances the print timing for the print head of the monochrome cartridge 32 by the correction amount ΔT2 calculated in step S15.

This reduces misalignment in printing results by the monochrome cartridge 32 arising from the translation of the carriage 31, thus increasing print quality.

In the first variation, the print timing is adjusted for when the carriage 31 translates in the direction Dir2, but the print timing may be adjusted for when the carriage 31 translates in the direction Dir1.

Moreover, if the color cartridge 33 is mounted in the carriage 31, the print timing for each print head of the color cartridge 33 may be adjusted using the correction amount ΔT2. Alternatively, the amount of misalignment for each print head of the color cartridge 33 may be detected, and the print timing for each print head of the color cartridge 33 may be adjusted from the detected amount of misalignment.

With the first variation as well, since the design for assisting the user is printed on the back side of the document using the duplex printing unit, user error, such as setting the document in the incorrect orientation, can be reduced. With the first variation, even if there is a structural inaccuracy from imprecise assembly that results in a print misalignment between when the carriage 31 translates in the direction Dir1 and translates in the direction Dir2, the print misalignment can be accurately corrected, thus increasing print quality.

### Second Variation

Correction of a misalignment between two cartridges as described in the embodiment and correction of a misalignment arising from translation of the carriage 31 as described in the first variation may be performed at the same time.

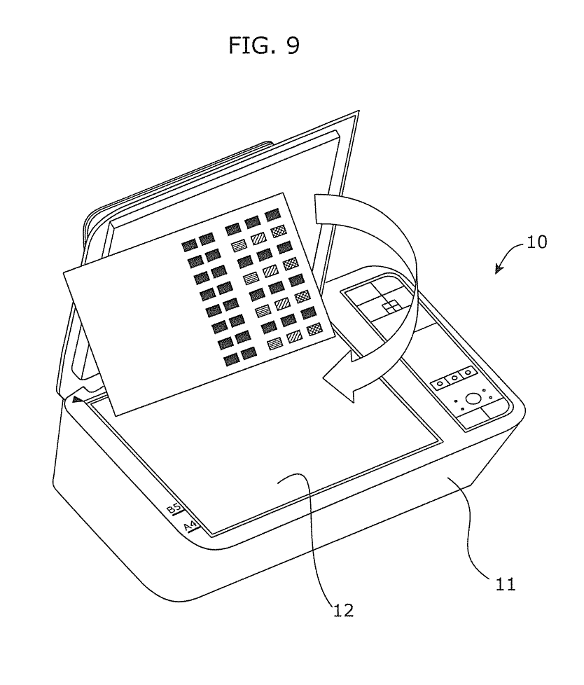

FIG. SC illustrates an example of the position detection pattern according to the second variation. FIG. 5C illustrates a document 60C. On the back side of document 60C, the pattern illustrated in FIG. 5A is printed on top, and the pattern illustrated in FIG. 5B is printed below. FIG. 9 illustrates an example of the printer when the document illustrated in FIG. 5C is being set on the glass platen.

In the second variation, the correction amount ΔT1 is calculated according to the same steps described in the embodiment and the correction amount ΔT2 is calculated according to the same steps described in the first variation.

Under normal printing circumstances, when the carriage 31 is translating in direction Dir2, the printing unit 43, for example, advances the print timing for the print head of the monochrome cartridge 32 by the correction amount ΔT2 calculated in step S15.

Moreover, the printing unit 43 adjusts the print timing for the print heads of the color cartridge 33 based on the direction in which the carriage 31 is translating. For example, the printing unit 43 advances the print timing for each print head of the color cartridge 33 by the correction amount ΔT1 when the carriage is translating in direction Dir1.

When the correction amount ΔT1 is greater than the correction amount ΔT2, the printing unit 43 retards the print timing for the color cartridge 33 by the correction amount ΔT1 minus the correction amount ΔT2 when the carriage is translating in direction Dir2. When the correction amount ΔT1 is less than the correction amount ΔT2, the printing unit 43 advances the print timing for the color cartridge 33 by the correction amount ΔT2 minus the correction amount ΔT1 when the carriage is translating in direction Dir2.

This reduces both print misalignment between the print heads of the color cartridge 33 and the print head of the monochrome cartridge 32 and print misalignment arising from the translation of the carriage 31, thus increasing print quality.

Note that the adjustment of the print timing for correcting print misalignment between two cartridges may be performed for the monochrome cartridge 32 as well. Alternatively, the adjustment of the print timing for correcting print misalignment arising from translation of the carriage 31 may be performed for when the carriage 31 translates in the direction Dir1.

In the second variation as well, since the design for assisting the user is printed on the back side of the document using the duplex printing unit, user error, such as setting the document in the incorrect orientation, can be reduced. Moreover, with the second variation, both print misalignment between two cartridges and print misalignment arising from the translation of the carriage 31 can be corrected in a single misalignment correction process.

### Third Variation

In the embodiment and the first and second variations, the pattern for assisting the user is a pattern resembling the third mark depicted on the chassis 10, but a graphic other than a pattern resembling the third mark may be printed.

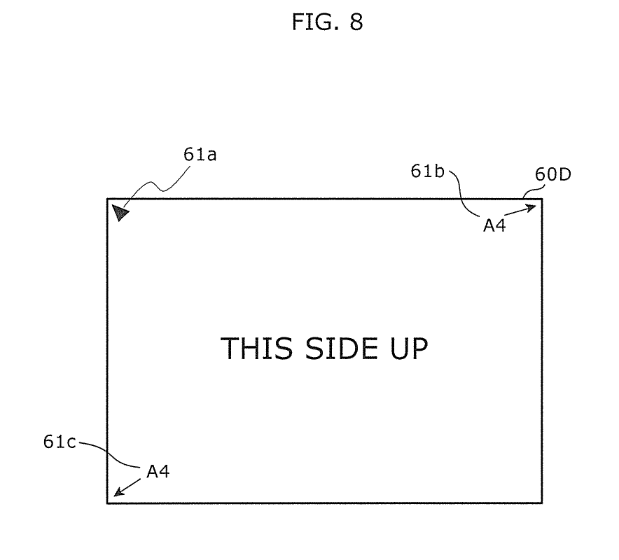

FIG. 8 illustrates an example of a design for assisting the user according to the third variation. In addition to the pattern illustrated in FIG. 6, the text “THIS SIDE UP” is printed on document 60D illustrated in FIG. 8.

This can further reduce the possibility of user error.

Although the above describes the printer according to an embodiment of the present invention and variations thereof, the present invention is not limited to this illustrative embodiment.

The control unit 40 included in the printer may be configured as, specifically, a computer system including, for example, a microprocessor, ROM, RAM, hard disk drive, display unit, keyboard or mouse. A computer program is stored in the RAM or the hard disk drive. The control unit 40 achieves its function as a result of the microprocessor operating according to the computer program. Here, the computer program is configured of a plurality of pieced together instruction codes indicating a command to the computer in order to achieve a given function.

Furthermore, some or all of the above structural elements included in the control unit 40 may be configured as a single system large scale integration (LSI). A system LSI is a multifunctional LSI manufactured by integrating a plurality of units on a single chip, and is specifically a computer system including, for example, a microprocessor, ROM, and RAM. A computer program is stored in the RAM. The system LSI achieves its function as a result of the microprocessor operating according to the computer program.

Moreover, some or all of the above structural elements included in the control unit 40 may be configured from an IC card detachably attached to the printer, or a standalone module. The IC card and the module are computer systems including a microprocessor, ROM, and RAM, for example. The IC card and the module may include the above multifunctional LSI. The IC card and the module achieve their function as a result of the microprocessor operating according to the computer program. The IC card and the module may be tamperproof.

Moreover, the present invention may be a method (process for correcting misalignment) described above. The present invention may also be a computer program realizing this method with a computer, or a digital signal of the computer program.

Moreover, the present invention may also be realized as a non-transitory computer-readable medium, such as a flexible disk, hard disk, CD-ROM, MO, DVD, DVD-ROM, DVD-RAM, BD (Blu-ray (R) Disc), or a semiconductor memory having the computer program or digital signal stored thereon. The present invention may also be realized as a digital signal stored on one or more of these non-transitory computer-readable mediums.

Moreover, the present invention may also transmit the computer program or the digital signal via, for example, an electric communication line, a wireless or wired line, a network such as the Internet, or data broadcasting.

Moreover, the present invention may be a computer system including memory storing the computer program and a microprocessor operating according to the computer program.

Moreover, the computer program or the digital signal may be implemented by a different independent computer system by being stored on the non-transitory computer-readable medium and transmitted, or sent via the network, for example.

Moreover, various aspects of the above embodiment and the above variations may be combined.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The printer according to the above-described embodiment and variations thereof is applicable as, for example, a printer including a duplex printing unit and a scanner function unit, or an all-in-one printer.

1. A printer comprising:
an image forming unit that forms a first mark on a first side of a medium and forms a second mark on a second side of the medium;
a platen for placing the medium including the first mark and the second mark formed by the image forming unit;
a frame including a third mark depicted in at least one portion of an area surrounding the platen;
a reading unit that reads the first mark formed on the first side of the medium placed on the platen; and
an adjusting unit that adjusts a printing position based on a result obtained by reading the first mark,
wherein the second mark is positioned opposite to the third mark when the reading unit reads the first mark.

2. The printer according to claim 1, further comprising
a carriage that includes one or more print heads and reciprocates along a predetermined axis,
wherein the adjusting unit adjusts a printing position of the one or more print heads based on the result obtained by reading the first mark.

3. The printer according to claim 2,
wherein the one or more print heads include a first print head and a second print head,
the first mark includes a first pattern and a second pattern,
the image forming unit prints the first pattern using the first print head and prints the second pattern using the second print head, and
the adjusting unit detects a distance between the first pattern and the second pattern from the result obtained by reading the first mark and adjusts a print timing of the second print head based on the distance between the first pattern and the second pattern.

4. The printer according to claim 3,
wherein a monochrome cartridge containing black ink and a color cartridge containing color ink are attached to the carriage,
the first print head corresponds to one of the monochrome cartridge and the color cartridge, and
the second print head corresponds to an other of the monochrome cartridge and the color cartridge.

5. The printer according to claim 3,
wherein the first pattern and the second pattern are alternately arranged in a translating direction of the carriage.

6. The printer according to claim 2,
wherein the first mark includes a third pattern and a fourth pattern,
the image forming unit prints the third pattern when the carriage is translating in a first direction and prints the fourth pattern when the carriage is translating in a second direction opposite the first direction, and
the adjusting unit detects a distance between the third pattern and the fourth pattern from the result obtained by reading the first mark and, based on the distance between the third pattern and the fourth pattern, adjusts a print timing of the one or more print heads when the one or more print heads are translating in the second direction.

7. The printer according to claim 6,
wherein a monochrome cartridge containing black ink and a color cartridge containing color ink are attached to the carriage, and
the third pattern and the fourth pattern are both printed using the print head corresponding to one of the monochrome cartridge and the color cartridge.

8. The printer according to claim 1,
wherein the image forming unit forms the second mark on the second side, in a region corresponding to a region on the first side in which the first mark is not formed.

9. The printer according to claim 1, further comprising
a duplex printing unit capable of automatically printing on both the first side and the second side of the medium,
wherein the image forming unit forms the first mark on the first side of the medium and forms the second mark on the second side of the medium using the duplex printing unit.

10. The printer according to claim 1,
wherein the second mark resembles the third mark.
